(19) United States
(12) Patent Application Publication
(10) Pub. No.: US 2014/0324482 A1
(43) Pub. Date: Oct. 30, 2014

(54) Vehicle Status Monitoring Apparatuses, Methods and Systems

(71) Applicant: DaVinci Solutions, LLC, Greenwich, CT (US)

(72) Inventor: Robert Wallach, Mill Neck, NY (US)

(73) Assignee: DaVinci Solutions, LLC, Greenwich, CT (US)

(21) Appl. No.: 14/213,843

(22) Filed: Mar. 14, 2014

Related U.S. Application Data
(60) Provisional application No. 61/798,811, filed on Mar. 15, 2013.

(51) Int. Cl. G06Q 40/08

(52) U.S. Cl. CPC G06Q 40/08
USPC 705/4

(57) ABSTRACT

SYSTEMS (“VSM”) transform insurance renewal requests via VSM components into VSM sticker color display change. A VSM sticker is described, including a Near Field Communication (NFC) chip configured to communicate with a user mobile device for vehicle status information; an energy supply component providing energy supplies; a color layer having a solid color display wherein the displayed color is changeable upon electronic instructions; and a memory storing the vehicle status information and the electronic instructions to change the displayed color of the color layer.

### PRIORITY CLAIM

This application is a non-provisional of and claims priority under 35 U.S.C. §119 to U.S. provisional application Ser. No. 61/798,811, filed Mar. 15, 2013, titled “VEHICLE STATUS MONITORING APPARATUSES, METHODS AND SYSTEMS.”

This application is related to PCT International application serial no. PCT/US2014/029267, filed Mar. 14, 2014, titled “VEHICLE STATUS MONITORING APPARATUSES, METHODS AND SYSTEMS.”

This application for letters patent discloses and describes various novel innovations and inventive aspects of VEHICLE STATUS MONITORING technology (hereinafter “VSM”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address apparatuses, methods, and systems for vehicle registration and insurance information capturing, and more particularly, include VEHICLE STATUS MONITORING APPARATUSES, METHODS

### BACKGROUND

Vehicle owners need to purchase insurance policy for their vehicles. A vehicle insurance policy lasts for a period of time. After the period of time, the insurance expires and the vehicle is uninsured. Under the circumstances, an uninsured vehicle cannot claim damages from an insurance carrier if any accident occurs.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIG. 1A provides illustrative examples showing aspects of VSM sticker color changes scenarios within embodiments of the VSM;

FIG. 1B provides an illustrative example showing VSM sticker 101 exemplary structure within embodiments of the VSM;

FIGS. 2A-2B provide exemplary data flow diagrams illustrating data flows between VSM and various affiliated entities within embodiments of the VSM;

FIGS. 3A-3B provide a logic flow illustrating aspects of insurance renewal updating within embodiments of the VSM;

FIGS. 3A-3B provide a logic flow illustrating aspects of insurance renewal updating within embodiments of the VSM;

FIG. 4 provides exemplary mobile user interface(s) (UI) within embodiments of the VSM; and

FIG. 5 shows a block diagram illustrating example aspects of a VSM controller.

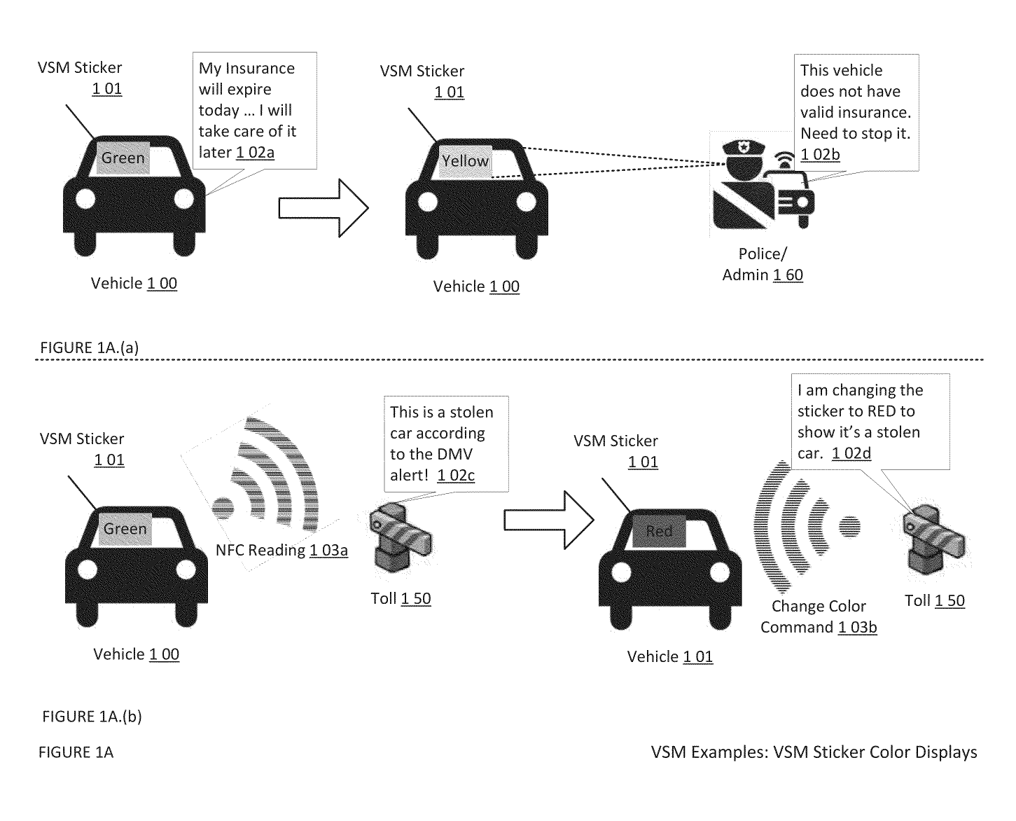

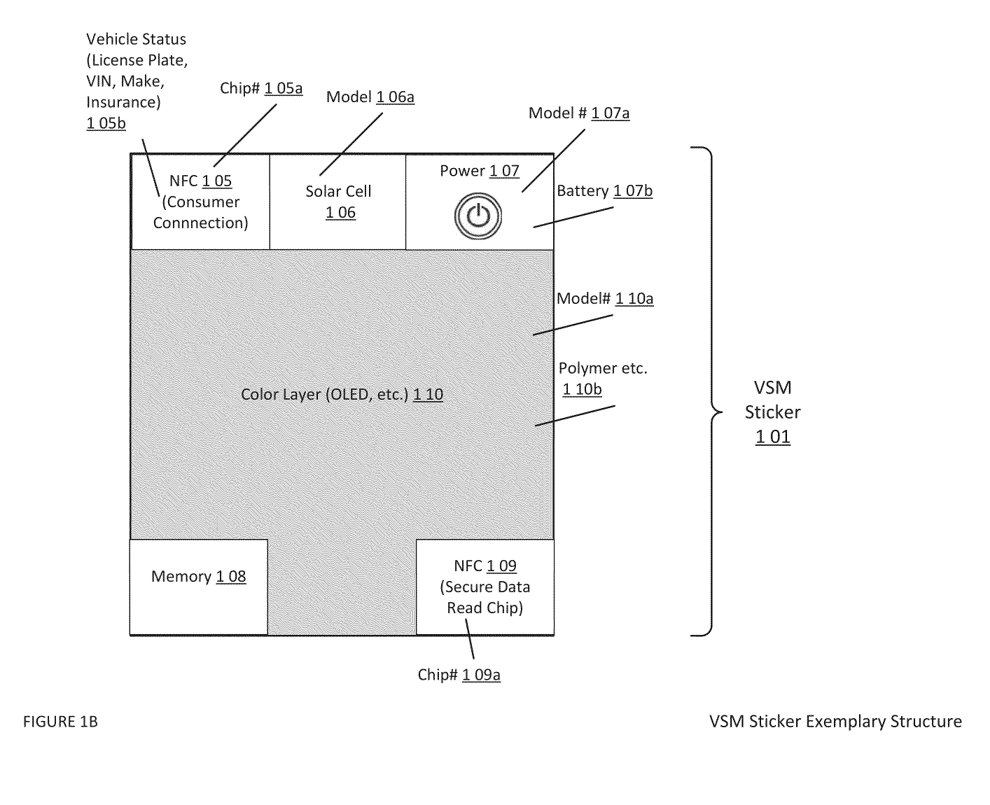

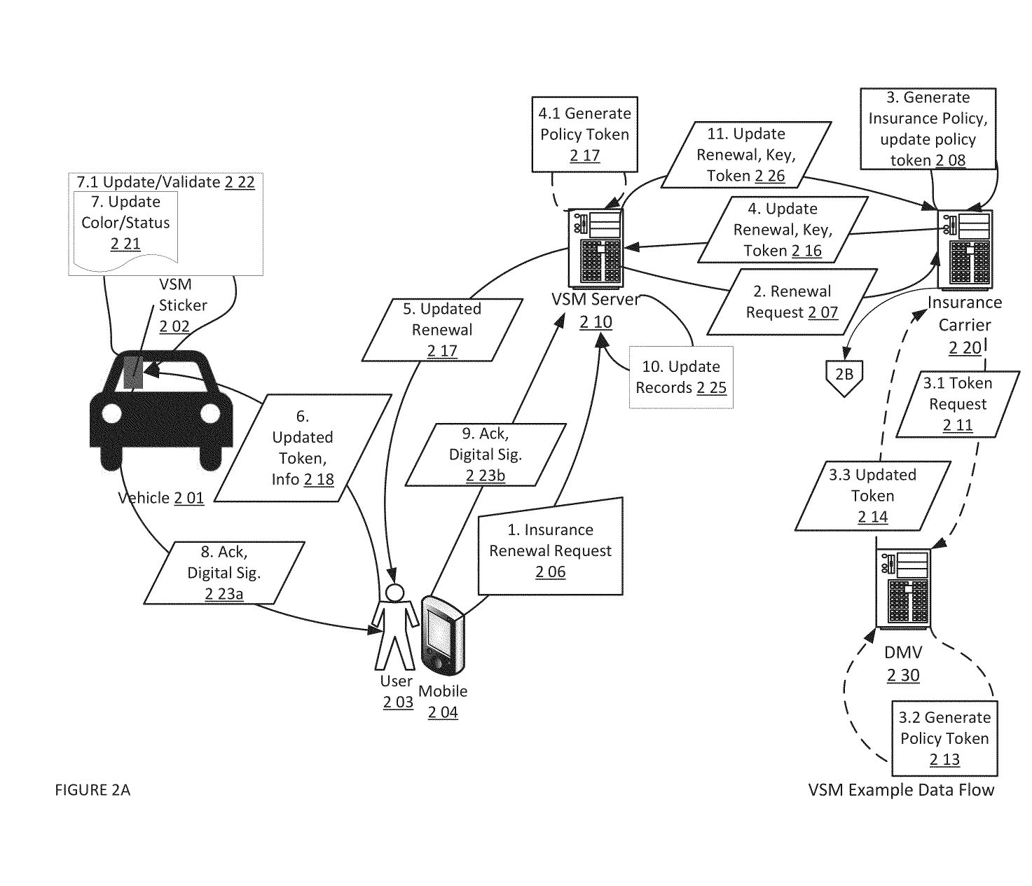

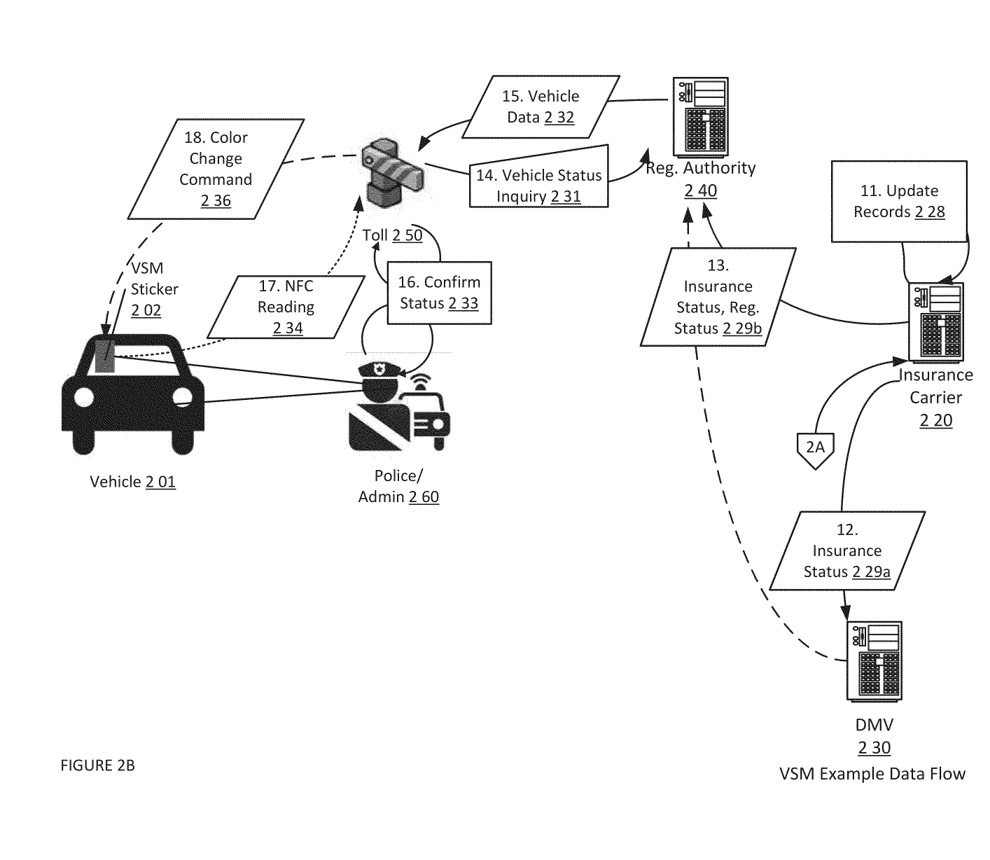

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The VEHICLE STATUS MONITORING technology (hereinafter “VSM”) provides a vehicle registration and insurance status monitoring and management platform. In one implementation, the VSM issues a portable sticker that may be attached to an observable part of the vehicle (e.g., the front or rear window of an automobile, the cover of a motorcycle, etc), wherein the sticker comprises a Near Field Communication (NFC) chip that can receive instructions from a Smartphone to change its display color. In one implementation, different display colors may represent different insurance/registration statuses of the vehicle, e.g., “green” for valid/insured, “yellow” for expired/uninsured, “red” for reported lost/stolen, etc. In this way, regulatory authorities (e.g., police patrol, etc.) may be able to capture status of a vehicle by observing the colors of the VSM stickers.

For example, in one implementation, the VSM sticker may comprise a palm size rectangular tag that may be attached to the front window of an automobile, and another identical tag that may be attached to the rear window of the automobile. The two tags may have the same display color so that the tag indicating an insurance/registration status of the automobile is observable from either the front or back side of the automobile. In one implementation, the stickers may be placed on a corner position so that they would not block the vision of the driver.

### Vehicle Status Monitoring (VSM)

FIG. 1A provides illustrative examples showing aspects of VSM sticker color changes scenarios within embodiments of the VSM. As shown in FIG. 1A.(a), a vehicle 100 may have attached the color-modifiable VSM sticker 101 to its window. When the insurance policy associated with the vehicle 100 expires but the owner fails to renew the insurance policy 102a, the VSM sticker may change color when it fails to receive an insurance renewal instruction from an NFC command, e.g., from “green” (insured) to “yellow” (uninsured). The police and/or other authority may capture the “yellow” VSM sticker and identify the vehicle 100 is uninsured, e.g., 102b.

As shown in FIG. 1A.(b), in another example, when the vehicle 100 drives through a toll station 150, the VSM sticker may exchange vehicle information (e.g., license plate, vehicle identification number (VIN), insurance, etc.) via NFC reading 103a with the toll 150. In one implementation, the toll 150 may identify the vehicle is a stolen vehicle based on the local DMV reports 102c, and may generate a NFC command to change the color of the VSM display 102d, e.g., from “green” (good) to “red” (stolen).

FIG. 1B provides an illustrative example showing VSM sticker 101 exemplary structure within embodiments of the VSM. In one implementation, the VSM sticker may comprise a rectangular, and/or other shaped color layer, which may be able to display different colors. In one implementation, the color layer 110 may comprise removable physical color layers made of paper, polymer, plastic 100b, and/or the like. In another implementation, the color layer may comprise an OLED display 110 that may change color according to instructions received from a NFC chip 105. In one implementation, the color layer 110 may comprise a model number 110a, and/or the like.

In one implementation, the VSM sticker may comprise a NFC chip 105 that serves for consumer connection (e.g., communicating with a consumer's Smartphone, etc.). In one implementation, the NFC chip 105 may be associated with a unique NFC chip number 105a, and provide vehicle status information 105b such as but not limited to license plate number, VIN, make and model, insurance policy, and/or the like. In one implementation, the VSM sticker may comprise a solar cell 106 that provide energy recharge to the VSM sticker, wherein the solar cell is associated with a model number 106a. In one implementation, the VSM sticker may further comprise a power control 107, wherein the power control module is associated with a model number 107a, and may be equipped with a button battery 107b.

In a further implementation, the VSM sticker 101 may comprise a memory chip 108, which may store commands and instructions (e.g., received from NFC handshake, etc.) to change colors, to reset, and/or the like. In one implementation, the VSM sticker 101 may further comprise a second secure NFC chip 109 for secure data reading, e.g., regulatory authorities may obtain information of the vehicle by handshaking with the NFC chip 109 with a NFC chip number 109a.

FIGS. 2A-2B provide exemplary data flow diagrams illustrating data flows between VSM and various affiliated entities within embodiments of the VSM. Within embodiments, a vehicle 201 installed with a VSM sticker 202, a user 203 operating a mobile device 204, a VSM server 210, an insurance carrier 220, DMV server 230, a toll system 250, a police/administrative personnel 260, a regulatory authority server 240, and/or the like, are interacted via a communication network.

In one embodiment, a user 203 may operate a mobile device 204 (e.g., a laptop, a PDA, a Smartphone, etc.) to request for an insurance renewal 206. For example, the user may fill in an insurance renewal form online, via email, and/or the like. In one implementation, a user device 204 may generate a Hypertext Transfer Protocol Secure (HTTPS) POST message to send insurance renewal information 206 in the form of data formatted according to the eXtensible Markup Language. Below is an example HTTP(S) POST message including an XML-formatted message of the insurance renewal request 206 for the VSM server 210:

```
POST /insurance_rewnew.php HTTP/1.1
Host: 192.168.23.126
Content-Type: Application/XML
Content-Length: 718
<?XML version = “1.0” encoding = “UTF-8”?>
<insurance_renew>
  <Time> 17:40:40 </Time>
  <Date> 09-09-2015 </Date>
  <client_details>
      <client_IP>192.168.23.126</client_IP>
      <client_type>smartphone</client_type>
      <client_model>HTC Hero</client_model>
      <OS>Android 2.2</OS>
      <VSMapp_installed_flag>true</VSMapp_installed_flag>
      ...
  </client_details>
  <user>
      <user_name> John Smith </user_name>
      <user_DOB> 10-21-1982 </user_DOB>
      <user_gender> male </user_gender>
      <user_address>
          <line1> 101 Palm Street </line1>
          <city> palm spring </city>
          <state> CA </state>
          ...
      <user_address>
      <user_phone> 000 000 0000 </user_phone>
      ...
  </user>
  <NFC_no> 12345GDSD </NFC_no>
  <vehicle>
      <manu> BMW </manu>
      <year> 2004 </year>
      <model> X5 </model>
      <color> black </color>
      <plate_no> 2XCW2 </plate_no>
      <VIN> 3434343434 </VIN>
      ...
  </vehicle>
  <insurance>
      <start> 01-01-2006 </start>
      <end> 01-01-2016 </end>
      <carrier> geico </carrier>
      <program_id> full-cov </program_id>
      <premium> 399.00 </premium>
      ...
  </insurance>
  <renew>
      <start> 01-01-2016 </start>
      <end> 01-01-2018 </end>
      <carrier> geico </carrier>
      <program_id> full-cov </program_id>
      ...
  </renew>
...
<insurance_renew>
```

Within implementations, the VSM server 210 may forward the renewal request 207 to an insurance carrier 220. In alternative implementations, the user may directly send the insurance renewal request 206 to the insurance carrier 220. In one implementation, upon receiving the renewal request, the insurance carrier 220 may generate an insurance policy for the user, and may update a policy token for VSM sticker 208. In another implementation, the insurance carrier may send a token request 211 to the local DMV server 23o, which may verify the record of the vehicle, and generate a policy token 213. In one implementation, the updated insurance token 214 may be returned to the insurance carrier 220. Below is an example HTTP(S) POST message including an XML-formatted message of the token request 211:

```
POST /token_request.php HTTP/1.1
Host: www.insurance.com
Content-Type: Application/XML
Content-Length: 718
<?XML version = “1.0” encoding = “UTF-8”?>
<token_request>
  <Time> 17:43:40 </Time>
  <Date> 09-09-2015 </Date>
  ...
  <user>
      <user_name> John Smith </user_name>
      <user_DOB> 10-21-1982 </user_DOB>
      <user_gender> male </user_gender>
      <user_address>
          <line1> 101 Palm Street </line1>
          <city> palm spring </city>
          <state> CA </state>
          ...
      <user_address>
      <user_phone> 000 000 0000 </user_phone>
      ...
  </user>
  <vehicle>
      <manu> BMW </manu>
      <year> 2004 </year>
      <model> X5 </model>
      <color> black </color>
      <plate_no> 2XCW2 </plate_no>
      <VIN> 3434343434 </VIN>
      ...
  </vehicle>
  <insurance_renew>
      <start> 01-01-20016 </start>
      <end> 01-01-2018 </end>
      <carrier> geico </carrier>
      <program_id> full-cov </program_id>
      <premium> 399.00 </premium>
      ...
  </insurance_renew>
  ...
<request> token </request>
<NFC_no> 12345GDSD </NFC_no>
...
</token_request>
```

In one implementation, in response to the token request, the DMV server 230 may generate a HTTPS POST message in the form of data formatted according to XML, wherein the XML-formatted message of the updated token 214 may take a form similar to the following:

```
POST /updated_token.php HTTP/1.1
Host: www.insurance.com
Content-Type: Application/XML
Content-Length: 718
<?XML version = “1.0” encoding = “UTF-8”?>
<token_request>
  <Time> 17:43:40 </Time>
  <Date> 09-09-2015 </Date>
  ...
  <user>
      <user_name> John Smith </user_name>
      <user_DOB> 10-21-1982 </user_DOB>
      <user_gender> male </user_gender>
      <user_address>
          <line1> 101 Palm Street </line1>
          <city> palm spring </city>
          <state> CA </state>
          ...
      <user_address>
      <user_phone> 000 000 0000 </user_phone>
      ...
  </user>
  <UserToken> fdsjreiorrgr8t9340548 </UserToken>
<NFC_no> 12345GDSD </NFC_no>
...
</updated_token>
```

In one implementation, the insurance carrier 220 may provide the updated renewal, keys, token 216 to the VSM server 210, and/or alternatively the VSM server 210 may generate the insurance policy token 217. In alternative implementations, the insurance server 220 may directly communicate with a user mobile device (e.g., via the mobile device client component, etc.) and provide/update vehicle information, e.g., vehicle make and model, VIN, plate number, registration information, insurance information, and/or the like. Such data updates may be performed on a mandatory basis (e.g., based on state regulatory requirement, etc.), or on a voluntary basis. Such data updates may be fed to the user mobile device continuously, periodically, intermittently, on demand, and/or the like.

In one implementation, the updated renewal information 217 and token information (e.g., similar to 3.1 and 3.3, etc.) may be provided to the user mobile device 204. The user may operate the mobile device 204 to send the updated token information 218 (e.g., similar to 217) to the VSM sticker 202. In one implementation, the token may include information to change to a color code for the VSM. For example, 24 the VSM sticker 202 may in turn update and validate the token information 222, and generate updated color/status 221 to change the color of the VSM display.

In one implementation, the updated token information 218 may further comprise NFC handshake instructions from a Smartphone application (e.g., see ??) to change colors, wherein the XML-formatted message of the NFC instructions 218 may take a form similar to the following:

```
<?XML version = “1.0” encoding = “UTF-8”?>
<updated_token>
  <Time> 17:43:40 </Time>
  <Date> 09-09-2015 </Date>
  ...
  <NFC_no> 12345GDSD </NFC_no>
  <UserToken> fdsjreiorrgr8t9340548 </UserToken>
  <insurance_renew>
      <start> 01-01-20016 </start>
      <end> 01-01-2018 </end>
      <carrier> geico </carrier>
      <program_id> full-cov </program_id>
      <premium> 399.00 </premium>
      ...
  </insurance_renew>
  <status> valid </status>
  <action> color green </action>
...
</updated_token>
```

In one implementation, upon color updating, the VSM sticker 202 may send acknowledgement digital signatures 223a to the user device 204, e.g., via NFC handshake, which may in turn forward the acknowledgement message 223b to the VSM server 210. For example, in one implementation, below is an example HTTP(S) POST message including an XML-formatted message of the acknowledgement message 223b:

```
POST /ack.php HTTP/1.1
Host: 192.158.92.132
Content-Type: Application/XML
Content-Length: 718
<?XML version = “1.0” encoding = “UTF-8”?>
<ack>
  <Time> 17:46:40 </Time>
  <Date> 09-09-2015 </Date>
  ...
  <user>
      <user_name> John Smith </user_name>
      <user_DOB> 10-21-1982 </user_DOB>
      <user_gender> male </user_gender>
      <user_address>
          <line1> 101 Palm Street </line1>
          <city> palm spring </city>
          <state> CA </state>
          ...
      <user_address>
      <user_phone> 000 000 0000 </user_phone>
      ...
  </user>
  <vehicle>
      <manu> BMW </manu>
      <year> 2004 </year>
      <model> X5 </model>
      <color> black </color>
      <plate_no> 2XCW2 </plate_no>
      <VIN> 3434343434 </VIN>
      ...
  </vehicle>
  <insurance_renew>
      <start> 01-01-20016 </start>
      <end> 01-01-2018 </end>
      <carrier> geico </carrier>
      <program_id> full-cov </program_id>
      <premium> 399.00 </premium>
      ...
  </insurance_renew>
  <status> updated </status>
  <color> green </color>
  ...
</ack>
```

Within implementations, the VSM server 210 may update its records 225 to store the insurance renewal, updated token, and/or may send such information 226 to the insurance carrier 220 which may update its records 228 to reflect the insurance renewal.

Continuing on with FIG. 2B, upon updating records 228, the insurance carrier 220 may send an insurance status 229a to the DMV server 230 to update the vehicle's registration status. In one implementation, the DMV 23o may optionally send the updated insurance status, registration status 229b to regulatory authorities 240. For example, below is an example HTTP(S) POST message including an XML-formatted message of the status message 229b:

```
POST /status_update.php HTTP/1.1
Host: 192.158.92.132
Content-Type: Application/XML
Content-Length: 718
<?XML version = “1.0” encoding= “UTF-8”?>
<status_update>
  <Time> 17:54:40 </Time>
  <Date> 09-09-2015 </Date>
  ...
  <user>
      <user_name> John Smith </user_name>
      <user_DOB> 10-21-1982 </user_DOB>
      <user_gender> male </user_gender>
      <user_address>
          <line1> 101 Palm Street </line1>
          <city> palm spring </city>
          <state> CA </state>
          ...
      <user_address>
      <user_phone> 000 000 0000 </user_phone>
      ...
  </user>
  <vehicle>
      <manu> BMW </manu>
      <year> 2004 </year>
      <model> X5 </model>
      <color> black </color>
      <plate_no> 2XCW2 </plate_no>
      <VIN> 3434343434 </VIN>
      ...
  </vehicle>
  <insurance_renew>
      <start> 01-01-20016 </start>
      <end> 01-01-2018 </end>
      <carrier> geico </carrier>
      <program_id> full-cov </program_id>
      <premium> 399.00 </premium>
      ...
  </insurance_renew>
  <VSM_status> green <VSM_status>
  <stolen_report> no </stolen_report>
  <violation> no</violation>
  ...
</status_update>
```

In one implementation, upon the information update, a toll system 250 may send a vehicle status request inquiry 231 to the regulatory authority 240, e.g., when a vehicle drives through the toll 250. Such vehicle status inquiry 231 may be in real-time, may come in a batch, and/or the like. For example, below is an example HTTP(S) POST message including an XML-formatted message of the vehicle status inquiry 231:

```
POST /vehicle_inquiry.php HTTP/1.1
Host: 192.158.92.132
Content-Type: Application/XML
Content-Length: 718
<?XML version = “1.0” encoding = “UTF-8”?>
<vehicle_inquiry>
  <Time> 17:56:46 </Time>
  <Date> 09-09-2015 </Date>
  ...
  <vehicle>
      <manu> BMW </manu>
      <year> 2004 </year>
      <model> X5 </model>
      <color> black </color>
      <plate_no> 2XCW2 </plate_no>
      <VIN> 3434343434 </VIN>
      ...
  </vehicle>
  <VSM_status> green <VSM_status>
  <information_request>
      <request1> DMV alert </request1>
      <request2> insurance status </request2>
      ...
  </information_reguest>
...
<vehicle_inquiry>
```

In one implementation, the regulatory authority 240 may provide the requested vehicle data 232 (e.g., the message data structure may be similar to message 231) to the toll system 250, which may confirm the vehicle status with a police patrol 260, e.g., via automatic phone calls, via emails, via instant messages, via SMS, and/or the like. For example, when the vehicle appears to be a stolen car, the toll 250 may notify the police 260 informing the location of the stolen car.

In an alternative implementation, the toll may read information from VSM via NFC 234, and generate a color change command 236 (which may be similar to 218) via NFC to change the color of VSM, e.g., “red” for reported lost/stolen.

In further implementations, the VSM stickers may serve as registration with DMV, e.g., each vehicle may register with the DMV in order to obtain a license plate and a VSM sticker. The DMV may provide and update vehicle license plate number to the insurance server, user mobile device, and/or the like.

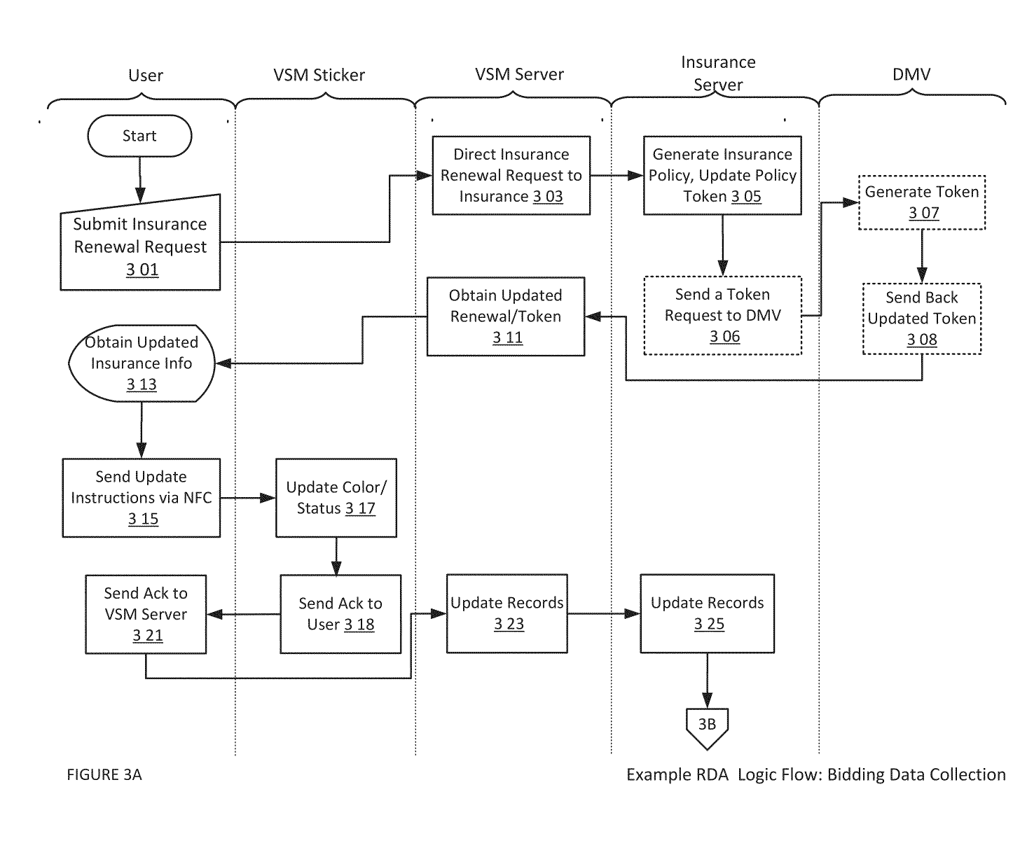

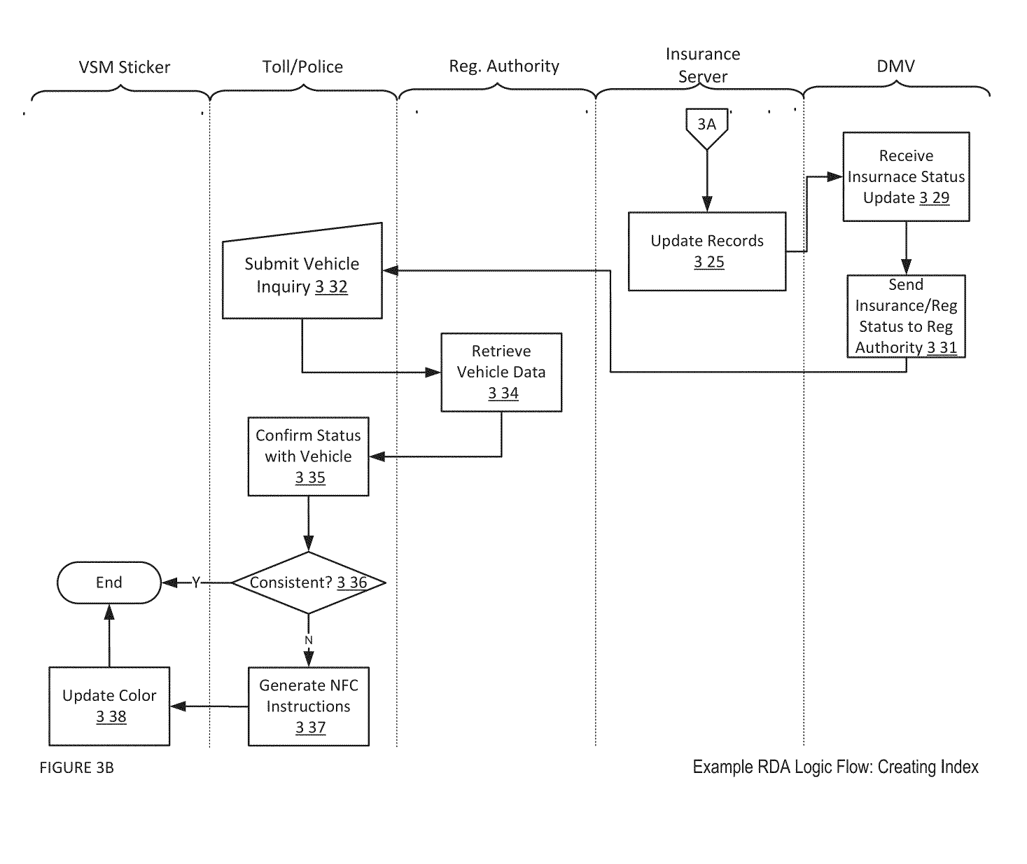

FIGS. 3A-3B provide a logic flow illustrating aspects of insurance renewal updating within embodiments of the VSM. Within embodiments, a user may submit an insurance renewal request (e.g., see 206 in FIG. 2A) to the VSM server, which may direct the request to an insurance server 303. The insurance server may generate insurance policy, update policy token, 305, and/or the like. Alternatively, the insurance server may send a token request to the DMV 306, wherein the DMV may generate the token 307, and send the updated token back 308.

In one implementation, the VSM server may obtain updated renewal token information 311, and send the updated insurance information to the user 313, e.g., at the user's mobile device. The user may operate the mobile device to scan a VSM sticker so as to trigger a NFC communication to send update instructions to the VSM sticker 315. In one implementation, the VSM sticker may update color/status 317 based on the renewed insurance policy.

In one implementation, the VSM sticker may send an acknowledgement message (e.g., see 223a in FIG. 2A) to the user device 318, which may forward the acknowledgement of successful updating to the VSM server 321. The VSM server may then update its insurance record 323, and the insurance server may accordingly update its record 325.

Continuing on with FIG. 3B, the DMV may receive an insurance status update 329, and may retrieve any information related to the vehicle (e.g., report lost/stolen, violations, parking tickets, etc.), and send insurance/registration status to a regulatory authority 331 (e.g., police, etc.).

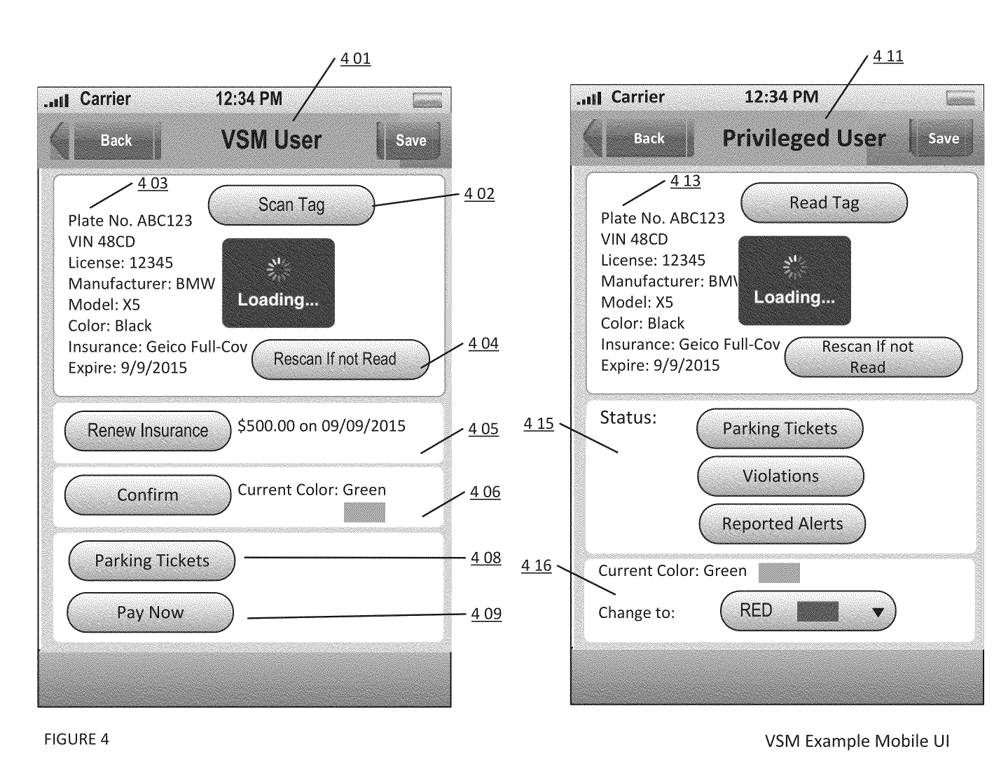

In one implementation, when a vehicle drives into a toll station, the toll/police may submit a vehicle inquiry 332 (e.g., based on the observed plate number, based on the VIN read from NFC handshake with VSM sticker, etc.). The regulatory authority may retrieve vehicle data 334, and send it to the toll/police. The toll may confirm status with vehicle 335, e.g., whether the displayed color on the VSM sticker is consistent with the updated vehicle data from the regulatory authority. If not consistent 336, e.g., the vehicle has been reported stolen, etc., the toll and/or police may generate NFC instructions (e.g., the police may operate a mobile device having a client component as “privileged user” as shown in FIG. 4) 337 to force the VSM sticker to change color 338.

FIG. 4 provides exemplary mobile user interface(s) (UI) within embodiments of the VSM. Within embodiments, a VSM user mobile UI may allow a user (e.g., a driver of a vehicle, etc.) to scan a VSM sticker 402. The mobile device may read the information via NFC handshake and provide the information 403. In one implementation, if the information displayed at 403 is incomplete, and user may rescan if not read 404.

In another implementation, the user may view an amount due to renew the insurance plan at 405, and elect to “renew insurance” to submit a renewal request (e.g., see 206 in FIG. 2A, etc.). In one implementation, the VSM UI may provide a status of the current color on the VSM sticker 405, and the user may confirm it. In further implementations, the VSM UI may provide options for the user to view and pay pending parking tickets 408-409.

In another implementation, the VSM may provide a different client component for privileged users (e.g., police, administrative authorities, etc.). As shown at 411, the VSM may provide similar VSM scanning and status 413 for the privileged users as that to VSM user described at 403.

In one implementation, the privileged user may view status 415 of a scanned user, e.g., parking tickets, violations, reported alerts, etc. In one implementation, the privileged user may verify the current color of the VSM sticker 416, and/or change the color if any irregularities found, e.g., the vehicle has been reported lost.

### VSM Controller

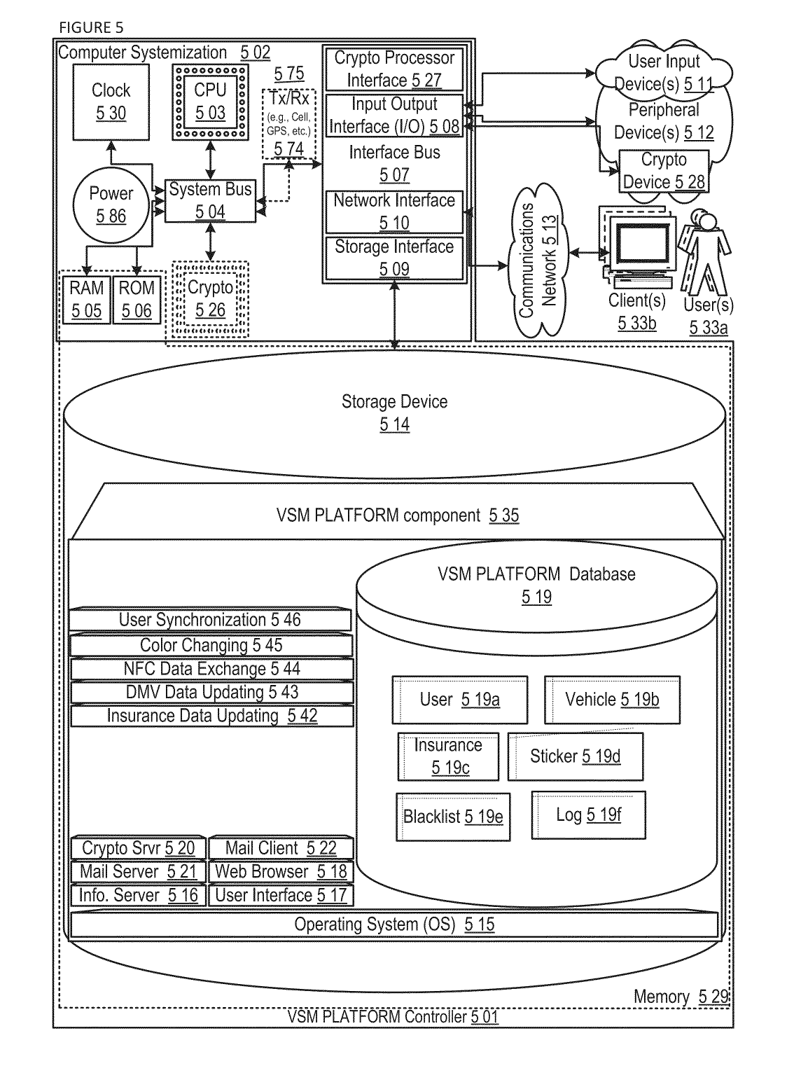

FIG. 5 shows a block diagram illustrating example aspects of a VSM controller 501. In this embodiment, the VSM controller 501 may serve to aggregate, process, store, search, serve, identify, instruct, generate, match, and/or facilitate interactions with a computer through various technologies, and/or other related data.

Users, e.g., 533a, which may be people and/or other systems, may engage information technology systems (e.g., computers) to facilitate information processing. In turn, computers employ processors to process information; such processors 503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the VSM controller 501 may be connected to and/or communicate with entities such as, but not limited to: one or more users from user input devices 511; peripheral devices 512; an optional cryptographic processor device 528; and/or a communications network 513. For example, the VSM controller 501 may be connected to and/or communicate with users, e.g., 533a, operating client device(s), e.g., 533b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The VSM controller 501 may be based on computer systems that may comprise, but are not limited to, components such as: a computer systemization 502 connected to memory 529.

### Computer Systemization

A computer systemization 502 may comprise a clock 530, central processing unit (“CPU(s)” and/or “processor(s)” (these terms are used interchangeably throughout the disclosure unless noted to the contrary)) 503, a memory 529 (e.g., a read only memory (ROM) 506, a random access memory (RAM) 505, etc.), and/or an interface bus 507, and most frequently, although not necessarily, are all interconnected and/or communicating through a system bus 504 on one or more (mother)board(s) 502 having conductive and/or otherwise transportive circuit pathways through which instructions (e.g., binary encoded signals) may travel to effectuate communications, operations, storage, etc. The computer systemization may be connected to a power source 586; e.g., optionally the power source may be internal. Optionally, a cryptographic processor 526 and/or transceivers (e.g., ICs) 574 may be connected to the system bus. In another embodiment, the cryptographic processor and/or transceivers may be connected as either internal and/or external peripheral devices 512 via the interface bus I/O. In turn, the transceivers may be connected to antenna(s) 575, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing VSM controller to determine its location)); Broadcom BCM4329FKUBG transceiver chip (e.g., providing 802.1 in, Bluetooth 2.1+EDR, FM, etc.), BCM28150 (HSPA+) and BCM2076 (Bluetooth 4.0, GPS, etc.); a Broadcom BCM4750IUB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA(2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor may construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core (2/Duo/i3/i5/i7), Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the VSM controller and beyond through various interfaces. Should processing requirements dictate a greater amount speed and/or capacity, distributed processors (e.g., Distributed VSM), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the VSM may be achieved by implementing a microcontroller such as CAST's R8051XC2 microcontroller; Intel's MCS 51 (i.e., 8051 microcontroller); and/or the like. Also, to implement certain features of the VSM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the VSM component collection (distributed or otherwise) and/or features may be implemented via the microprocessor and/or via embedded components; e.g., via ASIC, coprocessor, DSP, FPGA, and/or the like. Alternately, some implementations of the VSM may be implemented with embedded components that are configured and used to achieve a variety of features or signal processing.

Depending on the particular implementation, the embedded components may include software solutions, hardware solutions, and/or some combination of both hardware/software solutions. For example, VSM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects may be programmed by the customer or designer, after the FPGA is manufactured, to implement any of the VSM features. A hierarchy of programmable interconnects allow logic blocks to be interconnected as needed by the VSM system designer/administrator, somewhat like a one-chip programmable breadboard. An FPGA's logic blocks may be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the VSM may be developed on regular FPGAs and then migrated into a fixed version that more resembles ASIC implementations. Alternate or coordinating implementations may migrate VSM controller features to a final ASIC instead of or in addition to FPGAs. Depending on the implementation all of the aforementioned embedded components and microprocessors may be considered the “CPU” and/or “processor” for the VSM.

### Power Source

The power source 586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 586 is connected to at least one of the interconnected subsequent components of the VSM thereby providing an electric current to all the interconnected components. In one example, the power source 586 is connected to the system bus component 504. In an alternative embodiment, an outside power source 586 is provided through a connection across the I/O 508 interface. For example, a USB and/or IEEE 1394 connection carries both data and power across the connection and is therefore a suitable source of power.

### Interface Adapters

Interface bus(ses) 507 may accept, connect, and/or communicate to a number of interface adapters, frequently, although not necessarily in the form of adapter cards, such as but not limited to: input output interfaces (I/O) 508, storage interfaces 509, network interfaces 510, and/or the like. Optionally, cryptographic processor interfaces 527 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 509 may accept, communicate, and/or connect to a number of storage devices such as, but not limited to: storage devices 514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, Ethernet, fiber channel, Small Computer Systems Interface (SCSI), Thunderbolt, Universal Serial Bus (USB), and/or the like.

Network interfaces 510 may accept, communicate, and/or connect to a communications network 513. Through a communications network 513, the VSM controller is accessible through remote clients 533b (e.g., computers with web browsers) by users 533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed VSM), architectures may similarly be employed to pool, load balance, and/or otherwise increase the communicative bandwidth required by the VSM controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 510 may be used to engage with various communications network types 513. For example, multiple network interfaces may be employed to allow for the communication over broadcast, multicast, and/or unicast networks.

Input Output interfaces (I/O) 508 may accept, communicate, and/or connect to user input devices 511, peripheral devices 512, cryptographic processor devices 528, and/or the like. I/O may employ connection protocols such as, but not limited to: audio: analog, digital, monaural, RCA, stereo, and/or the like; data: Apple Desktop Bus (ADB), Bluetooth, IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 511 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 512 may be connected and/or communicate to I/O and/or other facilities of the like such as network interfaces, storage interfaces, directly to the interface bus, system bus, the CPU, and/or the like. Peripheral devices may be external, internal and/or part of the VSM controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the VSM controller may be embodied as an embedded, dedicated, and/or monitor-less (i.e., headless) device, wherein access may be provided over a network interface connection.

Cryptographic units such as, but not limited to, microcontrollers, processors 526, interfaces 527, and/or devices 528 may be attached, and/or communicate with the VSM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 184; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 529. However, memory is a fungible technology and resource, thus, any number of memory embodiments may be employed in lieu of or in concert with one another. It is to be understood that the VSM controller and/or a computer systemization may employ various forms of memory 529. For example, a computer systemization may be configured wherein the operation of on-chip CPU memory (e.g., registers), RAM, ROM, and any other storage devices are provided by a paper punch tape or paper punch card mechanism; however, such an embodiment may result in an extremely slow rate of operation. In one configuration, memory 529 may include ROM 506, RAM 505, and a storage device 514. A storage device 514 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 529 may contain a collection of program and/or database components and/or data such as, but not limited to: operating system component(s) 515 (operating system); information server component(s) 516 (information server); user interface component(s) 517 (user interface); Web browser component(s) 518 (Web browser); database(s) 519; mail server component(s) 521; mail client component(s) 522; cryptographic server component(s) 52o (cryptographic server); the VSM component(s) 535; and/or the like (i.e., collectively a component collection). These components may be stored and accessed from the storage devices and/or from storage devices accessible through an interface bus. Although non-conventional program components such as those in the component collection may be stored in a local storage device 514, they may also be loaded and/or stored in memory such as: peripheral devices, RAM, remote storage facilities through a communications network, ROM, various forms of memory, and/or the like.

### Operating System

The operating system component 515 is an executable program component facilitating the operation of the VSM controller. The operating system may facilitate access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. In addition, emobile operating systems such as Apple's iOS, Google's Android, Hewlett Packard's WebOS, Microsofts Windows Mobile, and/or the like may be employed. Any of these operating systems may be embedded within the hardware of the NICK controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the VSM controller to communicate with other entities through a communications network 513. Various communication protocols may be used by the VSM controller as a subcarrier transport mechanism for interaction, such as, but not limited to: multicast, TCP/IP, UDP, unicast, and/or the like.

### Information Server

An information server component 516 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C(++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the VSM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the VSM database 519, operating systems, other program components, user interfaces, Web browsers, and/or the like.

Access to the VSM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the VSM. In one embodiment, the information server may provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the VSM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millenium/15 Mobile/NT/XP/Vista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 517 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 518 is a stored program component that is executed by a CPU. The Web browser may be a hypertext viewing application such as Goofle's (Mobile) Chrome, Microsoft Internet Explorer, Netscape Navigator, Apple's (Mobile) Safari, embedded web browser objects such as through Apple's Cocoa (Touch) object class, and/or the like. Secure Web browsing may be supplied with 128 bit (or greater) encryption by way of HTTPS, SSL, and/or the like. Web browsers allowing for 19 the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application may similarly effect the obtaining and the provision of information to users, user agents, and/or the like from the VSM equipped nodes. The combined application may be nugatory on systems employing standard Web browsers.

### Mail Server

A mail server component 521 is a stored program component that is executed by a CPU 503. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server may route, forward, and process incoming and outgoing mail messages that have been sent, relayed and/or otherwise traversing through and/or to the VSM.

Access to the VSM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 522 is a stored program component that is executed by a CPU 503. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 520 is a stored program component that is executed by a CPU 503, cryptographic processor 526, cryptographic processor interface 527, cryptographic processor device 528, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the VSM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the VSM component to engage in secure transactions if so desired. The cryptographic component facilitates the secure accessing of resources on the VSM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The VSM Database

The VSM database component 519 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the VSM database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases may include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the VSM database is implemented as a data-structure, the use of the VSM database 519 may be integrated into another component such as the VSM component 535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 519 includes several tables 519a-f. A Users table 519a may include fields such as, but not limited to: user_id, user_device_id, username, password, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a VSM. A Vehicle table 519b may include fields such as, but not limited to: vehicle_plate_number, vin, vehicle_insurance_status, vehicle_color, vehicle_manufacturer, vehicle_make, vehicle_model, vehicle_DMV_reg, and/or the like. An Insurance table 519c may include fields such as, but not limited to: insurance_id, insurance carrier id, insurance_program_no, insurance_no, insurance_policy_code, insurance start date, insurance_exp_date, insurance_premium, and/or the like. A Sticker 519d may include fields such as, but not limited to: sticker_id, sticker_NFC_no, sticker_solar_cell_no, sticker_model_no, sticker_NFC_{—}2_no, sticker_status, sticker_vin, sticker_plate_num, sticker_insurance_id, and/or the like. A Blacklist table 519e may include fields such as but not limited to: vehicle_id, stolen_status, alert_status, violation, registration status, and/or the like. A Log table 519e may include fields such as, but not limited to: log_id, log_timestamp, log_date, log_user_id, log_device_id, log_server_ip, log_user_id, log_vin, log_sticker_id, log_event_code, log_color, log_alert, and/or the like.

In one embodiment, the VSM database may interact with other database systems. For example, employing a distributed database system, queries and data access by search VSM component may treat the combination of the VSM database, an integrated data security layer database as a single database entity.

In one embodiment, user programs may contain various user interface primitives, which may serve to update the VSM. Also, various accounts may require custom database tables depending upon the environments and the types of clients the VSM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 519a-f. The VSM may be configured to keep track of various settings, inputs, and parameters via database controllers.

The VSM database may communicate to and/or with other components in a component collection, including itself, and/or facilities of the like. Most frequently, the VSM database communicates with the VSM component, other program components, and/or the like. The database may contain, retain, and provide information regarding other nodes and data.

### The VSMs

The VSM component 535 is a stored program component that is executed by a CPU. In one embodiment, the VSM component incorporates any and/or all combinations of the aspects of the VSM discussed in the previous figures. As such, the VSM affects accessing, obtaining and the provision of information, services, transactions, and/or the like across various communications networks. The features and embodiments of the VSM discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the VSM's features and facilities, and in many cases reduce the costs, energy consumption/requirements, and extend the life of VSM's underlying infrastructure; this has the added benefit of making the VSM more reliable. Similarly, many of the features and mechanisms are designed to be easier for users to use and access, thereby broadening the audience that may enjoy/employ and exploit the feature sets of the VSM; such ease of use also helps to increase the reliability of the VSM. In addition, the feature sets include heightened security as noted via the Cryptographic components 520, 526, 528 and throughout, making access to the features and data more reliable and secure.

The VSM component may transform insurance renewal requests (e.g., see 203 in FIG. 2A, etc.) via VSM components, such as but not limited to insurance data updating 542 (e.g., 216 in FIG. 2A, etc.), DMV data updating 543 (e.g., see 213 in FIG. 2A, etc.), NFC data exchange 544 (e.g., see 105 in FIG. 1B, etc.), color changing 545 (e.g., see 110 in FIG. 1B; 222 in FIG. 2A, etc.), user synchronization 546 (e.g., see 317-325 in FIG. 3A, etc.), and/or the like into VSM sticker color display change (e.g., see 110 in FIG. 1B, etc.), and/or the like and use of the VSM.

The VSM component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); Representational State Transfer (REST); SWFObject; Yahoo! User Interface; and/or the like), WebObjects, and/or the like. In one embodiment, the VSM server employs a cryptographic server to encrypt and decrypt communications. The VSM component may communicate to and/or with other components in a component collection, including itself, and/or facilities of the like. Most frequently, the VSM component communicates with the VSM database, operating systems, other program components, and/or the like. The VSM may contain, communicate, generate, obtain, and/or provide program component, system, user, and/or data communications, requests, and/or responses.

### Distributed VSMs

The structure and/or operation of any of the VSM node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that may dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the VSM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the VSM controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message do {
  $input = “”;
  $input = socket_read($client, 1024);
  $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

```
http://www.xav.com/perl/site/lib/SOAP/Parser.html
http://publib.boulder.ibm.com/infocenter/tivihelp/
    v2r1/index.jsp?topic=/com.ibm.IBMDI.doc/
    referenceguide295.htm
```

and other parser implementations:

```
http://publib.boulder.ibm.com/infocenter/tivihelp/
    v2r1/index.jsp?topic=/com.ibm.IBMDI.doc/
    referenceguide259.htm
```

all of which are hereby expressly incorporated by reference herein.

In order to address various issues and advance the art, the entirety of this application for VEHICLE STATUS MONITORING APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a VSM individual and/or enterprise user, database configuration and/or relational model, data type, data transmission and/or network framework, syntax structure, and/or the like, various embodiments of the VSM may be implemented that allow a great deal of flexibility and customization. For example, aspects of the VSM may be adapted for data network bandwidth management. While various embodiments and discussions of the VSM have been directed to vehicle registration and insurance information capturing, however, it is to be understood that the embodiments described herein may be readily configured and/or customized for a wide variety of other applications and/or implementations.

What is claimed is:

1. A vehicle status monitoring processor-implemented method, comprising:
instantiating a vehicle status monitoring client component on a user mobile device;
submitting a vehicle insurance renewal request;
obtaining a vehicle insurance renewal confirmation token at the user mobile device;
communicating with a vehicle tag being placed as part of the vehicle via a near field communication (NFC) connection through the vehicle status monitoring client component on a user mobile device;
sending vehicle insurance renewal information updates including the vehicle insurance renewal confirmation token to the vehicle tag; and
obtaining an acknowledgement message indicating that the vehicle tag has changed a display color in accordance with the vehicle insurance renewal information.

2. The method of claim 1, wherein the user mobile device comprises a Smartphone.

3. The method of claim 1, wherein the vehicle insurance renewal request is submitted prior to an expiry of an insurance policy associated with the vehicle.

4. The method of claim 1, wherein the vehicle insurance renewal confirmation token comprising encoded vehicle insurance renewal information.

5. The method of claim 1, wherein the vehicle tag comprises a Near Field Communication (NFC) chip configured to communicate with the user mobile device for 6 vehicle status information.

6. The method of claim 1, wherein the vehicle tag comprises:
a color layer having a solid color display wherein the displayed color is changeable upon electronic instructions.

7. The method of claim 1, wherein the vehicle tag comprises:
an energy supply component providing energy supplies.

8. The method of claim 7, wherein the vehicle tag comprises:
a memory storing the vehicle status information and the electronic instructions to change the displayed color of the color layer.

9. The method of claim 1, wherein the vehicle tag is placed at a window of the vehicle.

10. The method of claim 1, further comprising:
sending the acknowledgement message to an insurance carrier for record updating.

11. A vehicle status monitoring apparatus, comprising:
a Near Field Communication (NFC) chip configured to communicate with a user mobile device for vehicle status information;
an energy supply component providing energy supplies;
a color layer having a solid color display wherein the displayed color is changeable upon electronic instructions; and
a memory storing the vehicle status information and the electronic instructions to change the displayed color of the color layer.

12. The apparatus of claim 11, wherein the vehicle status information comprises insurance renewal information of the vehicle.

13. The apparatus of claim 11, wherein the displayed color is indicative of a vehicle insurance status.

14. The apparatus of claim 11, wherein the solid color display comprises an OLED display.

15. The apparatus of claim 11, wherein the electronic instructions are provided via the NFC communication with the user mobile device.

16. The apparatus of claim 11, wherein the energy supply component comprises a solar cell.

17. The apparatus of claim 11, wherein the vehicle status information comprises any of:
vehicle plate number;
vehicle identification number; and
vehicle make.

18. The method of claim 11, wherein the color layer is made of polymer.

19. A vehicle status monitoring system, comprising:
means for instantiating a vehicle status monitoring client component on a user mobile device;
means for submitting a vehicle insurance renewal request;
means for obtaining a vehicle insurance renewal confirmation token at the user mobile device;
means for communicating with a vehicle tag being placed as part of the vehicle via a near field communication (NFC) connection through the vehicle status monitoring client component on a user mobile device;
means for sending vehicle insurance renewal information updates including the vehicle insurance renewal confirmation token to the vehicle tag; and
means for obtaining an acknowledgement message indicating that the vehicle tag has changed a display color in accordance with the vehicle insurance renewal information.

20. A vehicle status monitoring processor-readable non-transitory storage medium storing processor-executable instructions executable by a processor to:
instantiate a vehicle status monitoring client component on a user mobile device;
submit a vehicle insurance renewal request;
obtain a vehicle insurance renewal confirmation token at the user mobile device;
communicate with a vehicle tag being placed as part of the vehicle via a near field communication (NFC) connection through the vehicle status monitoring client component on a user mobile device;
send vehicle insurance renewal information updates including the vehicle insurance renewal confirmation token to the vehicle tag; and
obtain an acknowledgement message indicating that the vehicle tag has changed a display color in accordance with the vehicle insurance renewal information.
